(19) United States
(12) Patent Application Publication
(10) Pub. No.: US 2021/0384850 A1
(43) Pub. Date: Dec. 9, 2021

(54) DISTRIBUTED PROPULSION WITH THERMAL MANAGEMENT

(71) Applicant: Bell Textron Inc., Fort Worth, TX (US)

(72) Inventors: Marc BUSTAMANTE, Montreal (CA); Chen KUANG, Montreal (CA); Thuvaragan SENTHILNATHAN, Laval (CA); Marc OUELLET, Sainte-Sophie (CA); Guillaume BIRON, Blainville (CA)

(73) Assignee: Bell Textron Inc., Fort Worth, TX (US)

(21) Appl. No.: 16/891,971

(22) Filed: Jun. 3, 2020

(51) Int. Cl. H02P 5/48; B64D 31/06; B64D 27/02; B64C 27/82; B64C 27/78; B64C 27/64

(52) U.S. Cl. CPC H02P 5/48; B64D 31/06; B64D 27/02; B64C 2027/8254; B64C 27/78; B64C 27/64; B64C 2027/8227; B64C 27/82

(57) ABSTRACT

An exemplary distributed propulsion system with thermal management includes two or more rotors individually controlled by associated motors and an input control connected to the associated motors to demand the associated motors produce a demanded thrust, wherein a motor power output of each motor of the associated motors is independently controlled to produce the demanded thrust and to control a motor temperature of one or more of the associated motors.

### TECHNICAL FIELD

This disclosure relates in general to the field of aircraft, and more particularly, to flight control.

### BACKGROUND

This section provides background information to facilitate a better understanding of the various aspects of the disclosure. It should be understood that the statements in this section of this document are to be read in this light, and not as admissions of prior art.

Without limiting the scope of this disclosure, the background is described in connection with anti-torque systems. Counter-torque tail rotors are often used in helicopters and are generally mounted adjacent to vertical fins that provide for aircraft stability. In such a configuration, the helicopter rotor produces a transverse airflow. Tail rotors can be driven at high angular velocities to provide adequate aerodynamic responses. Sometimes, vortices produced by a main helicopter rotor and the tail rotor can interact to reduce the efficiency of the thrust created by the rotors. The interference of the vortices may also cause an increase in noise.

### SUMMARY

An exemplary distributed propulsion system with thermal management includes two or more rotors individually controlled by associated motors and an input control connected to the associated motors to demand the associated motors produce a demanded thrust, wherein a motor power output of each motor of the associated motors is independently controlled to produce the demanded thrust and to control a motor temperature of one or more of the associated motors.

An exemplary method of operating a distributed propulsion system with thermal management includes operating a plurality of rotors individually driven by motors to produce a demanded thrust, sensing a motor temperature of each of the motors, reducing a power output of at least one first motor of the motors in response to the motor temperature of the at least one first motor exceeding a temperature threshold and increasing, in response to reducing the power output of the at least one first motor, a power output of at least one second motor of the motors to substantially maintain the demanded thrust.

An exemplary method of operating a helicopter includes operating, during flight, a matrix of rotors located on a tail boom to produce a demanded total thrust, each rotor of the matrix of rotors individually driven by a respective motor, monitoring a motor temperature of each of the motors, reducing a thrust of a first rotor of the matrix of rotors in response to the motor temperature of the respective motor exceeding a temperature threshold and increasing a thrust of a second rotor of the matrix of rotors in response to reducing the thrust of the first rotor.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates an exemplary aircraft incorporating an exemplary distributed propulsion system with thermal management according to one or more aspects of the disclosure.

FIG. 2 illustrates an exemplary distributed anti-torque propulsion system with thermal management according to one or more aspects of the disclosure.

FIG. 2A illustrates an exemplary liquid cooled distributed propulsion system with thermal management according to one or more aspects of the disclosure.

FIG. 3 illustrates an exemplary distributed propulsion system with thermal management according to one or more aspects of the disclosure.

FIG. 4 illustrates an exemplary method of operating a distributed propulsion system with thermal management according to one or more aspects of the disclosure.

FIG. 5 illustrates an exemplary method of operating a distributed propulsion system with thermal management according to one or more aspects of the disclosure.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

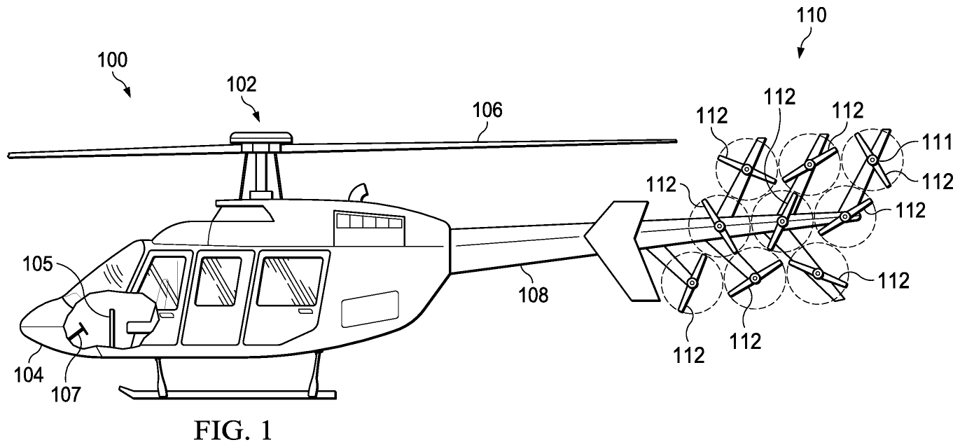

FIG. 1 illustrates an exemplary rotary aircraft 100, shown as a helicopter, having a distributed propulsion matrix 110 with a plurality of rotors 112, i.e., fans, blades, each directly driven by an associated motor 111. In this example, distributed propulsion matrix 110 is implemented as an anti-torque matrix 110 and includes nine rotors 112 and nine associated motors 111. Each motor 111 is driven to produce a thrust.

Exemplary aircraft 100 includes a rotary system 102 carried by a fuselage 104. Rotor blades 106 connected to rotary system 102 provide flight. Rotor blades 106 are controlled by multiple controllers within the fuselage 104. For example, during flight, a pilot can manipulate controllers 105, 107 for changing a pitch angle of rotor blades 106 and to provide vertical, horizontal and yaw flight control. Exemplary aircraft 100 has a tail boom 108, which supports anti-torque matrix 110 at the aft end. Each of rotors 112 can be operated individually or in groups to provide a net thrust for example for transversely stabilizing exemplary aircraft 100. As further described herein, motors 111 can be operated individually or in groups at different speeds to produce the pilot demanded thrust and to control the motor temperatures to avoid or alleviate overheating.

Although the distributed propulsion system is described herein with reference to an anti-torque system, it is understood that the system and control can be implemented in other distributed propulsion systems and in manned and unmanned rotary aircraft. Teachings of certain embodiments recognize that rotors 112 may represent one example of a rotor or anti-torque rotor; other examples include, but are not limited to, tail propellers, ducted tail rotors, and ducted fans mounted inside and/or outside the aircraft. Teachings of certain embodiments relating to rotors and rotor systems may apply to rotor systems, such as distributed rotors, tiltrotor, tilt-wing, and helicopter rotor systems. It should be appreciated that teachings herein apply to manned and unmanned vehicles and aircraft including without limitation airplanes, rotorcraft, hovercraft, helicopters, and rotary-wing vehicles.

The fan assemblies may be fixed pitch rotors with a variable speed motor, variable pitch rotors with a variable speed motor, or variable pitch rotors with fixed speed motors. In some embodiments, the motor is an electric motor and at least one of: a self-commutated motor, an externally commutated motor, a brushed motor, a brushless motor, a linear motor, an AC/DC synchronized motor, an electronic commutated motor, a mechanical commutator motor (AC or DC), an asynchronous motor (AC or DC), a pancake motor, a three-phase motor, an induction motor, an electrically excited DC motor, a permanent magnet DC motor, a switched reluctance motor, an interior permanent magnet synchronous motor, a permanent magnet synchronous motor, a surface permanent magnet synchronous motor, a squirrel-cage induction motor, a switched reluctance motor, a synchronous reluctance motor, a variable-frequency drive motor, a wound-rotor induction motor, an ironless or coreless rotor motor, or a wound-rotor synchronous motor. In another aspect, the motor is a hydraulic motor is at least one of: a gear and vane motor, a gerotor motor, an axial plunger motor, a constant pressure motor, a variable pressure motor, a variable flow motor, or a radial piston motor.

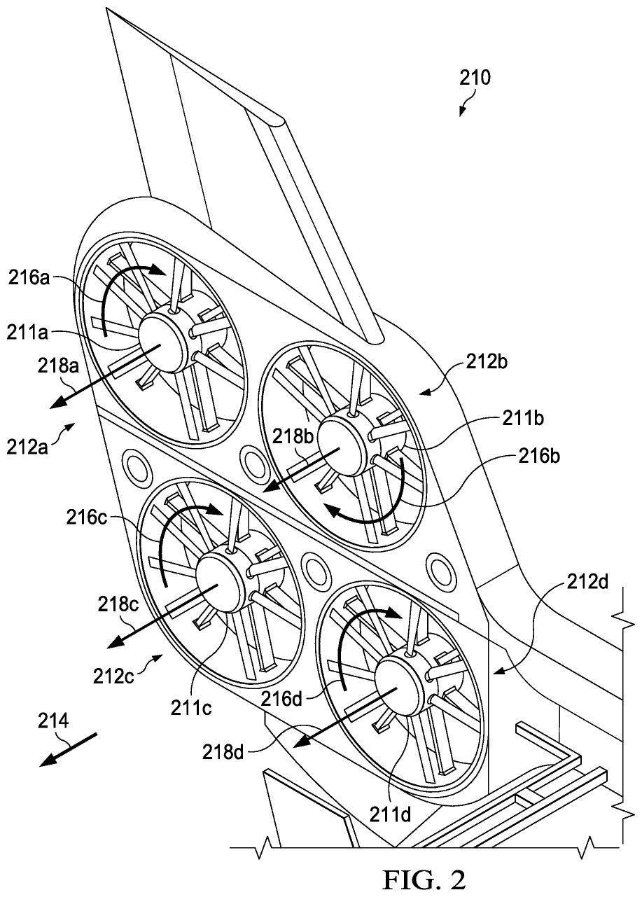

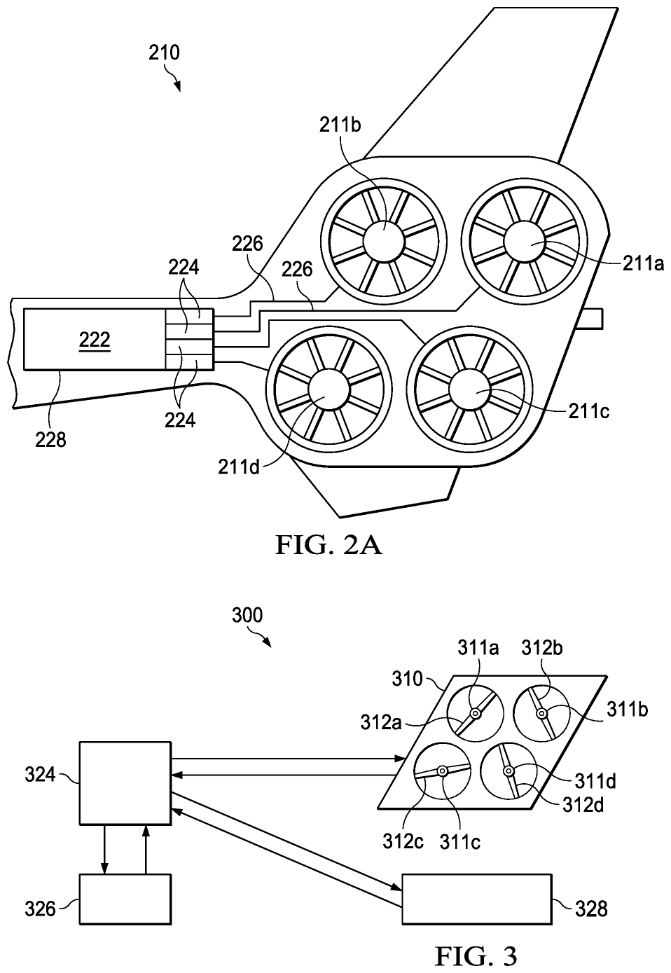

FIG. 2 illustrates an exemplary anti-torque matrix 210 having four shrouded rotors generally denoted with the numeral 212 and individually designated 212a-212d. In FIG. 2, rotors 212a-212d are driven, directly by motors 211a-211d. Exemplary embodiments are generally described herein with reference to fixed pitch rotors individually driven by variable speed motors. However, in some embodiments the rotors may be variable pitch rotors that are individually driven by variable or fixed speed motors. In operation, a pilot can control the thrust, e.g., demanded thrust or net thrust, of anti-torque matrix 210, for example, through operation of pilot controls, e.g., pedals 107 (FIG. 1). Through operation of the controls, the rotational speed and/or rotor pitch and the direction of rotation of rotors 212a-212d can be manipulated to produce a demanded thrust 214. In an embodiment, a flight control computer, e.g. logic, can control the motor power output of one or more motors 211a-211d to alter the thrust to achieve a desired aircraft yaw rate in response to the pilot's control inputs, which can include positive, negative, or zero yaw rate. As further described, flight control computer can control the thrust of individual rotors and thus the power consumption or output of the associated individual motors to mitigate overheating of the motors.

FIG. 2 illustrates anti-torque matrix 210 producing a thrust 214. In FIG. 2, individual fixed pitch rotors 212a-212d are operated at individual rotational speeds 216a-216d to produce individual thrusts 218a-218d resulting in anti-torque matrix thrust 214. When producing a high thrust 214 the individual motors 211a-211d are operated at a rotational speed that is a high percentage of the maximum rated speed (RPM) of motor 211a-211d. In some embodiments, rotors 212a-212d are variable pitch rotors and thrust is controlled by changing the pitch of the rotors. As the motor power increases, e.g., increased speed or torque, the temperature of the motor and/or motor controller increases. Motor temperature is also influenced by factors, such as altitude, ambient temperature, humidity, and the location of a motor in the matrix or rotors. If motor temperature is too high, the motor may lose power, be damaged, or fail. According to exemplary embodiments, thermal management monitors temperature of the individual motors and can reduce the load on the motor to allow cooling. In accordance to an embodiment, the motor speed is reduced or stopped in response to the motor temperature exceeding motor temperature threshold. In another exemplary embodiment, the pitch of the rotor blade can be changed, e.g. the angle of attack of the blade reduced, resulting in a lower power demand on the motor for the same RPM. The motor temperature threshold may be selected and set based on various criteria. For example, in response to a first motor reaching the high motor temperature threshold, the thermal management control may reduce the motor power output (e.g., speed and/or torque) of the first motor for a period of time allowing the first motor to cool. The period of time may be set, for example, as a predetermined time or based on motor temperature feedback. In some embodiments, the thrust of one or more of the other motors may be increased, e.g. increase motor speed and/or blade pitch change, to maintain the pilot demanded thrust 214.

When two or more motors exceed the temperature threshold, the power output of each of the motors may be adjusted to its best operating power output range, for example the best operational speed and at different target RPMs. In some embodiments, reducing motor power output pursuant to thermal management may result in a reduction of the thrust below a pilot demanded thrust. Accordingly, the thermal management can allow a pilot to override reducing thrust from the overheating motor to maintain the required thrust and provide the time for the pilot to maneuver out of the high thrust conditions.

FIG. 2A illustrates an exemplary anti-torque matrix 210 with liquid cooled motors. Liquid cooling system 220 includes a liquid coolant 222 that is circulated to cool the individual motors of plurality of motors 211a-211d. Liquid cooling system 220 includes regulators 224 in communication with the conduits 226 between the coolant reservoir 228 and the individual motors, e.g. motors 211a-211d. Regulators 224 may be valves, thermostats, actuators or other devices that regulate or control the flow of coolant through the associated conduit. Regulators 224 may be in communication with the thermal management logic and motor temperature sensors. Upon indication that a motor temperature meets or exceeds a threshold temperature the regulator can be manipulated to cool the high temperature motor.

FIG. 3 illustrates an exemplary control system 300 for use with a distributed propulsion matrix 310 having a plurality of rotors 312a-312d each driven by a motor 311a-311d. The rotors may be fixed pitch, whereby thrust is controlled by motor speed or variable pitch rotors driven by fixed or variable speed motors. A control logic 324 with thermal management is connected to a pilot input controls, e.g. pedals 107 (FIG. 1), and temperature sensors 326. Each motor 311a-311d may comprise a temperature sensor 326 to monitor the individual motor temperatures. Temperature sensor 326 may read temperature for example in the motor windings or stator. Control logic 324 is connected to motors 311a-311d and controls the thrust of rotors 312a-312d. Control logic 324 is connected to a table 328 that includes, for example, motor speed versus thrust for each of motors 311a-311d and or motor torque and rotor pitch versus thrust. Table 324 may be integrated in control logic 324. Control logic 324 may look up the motor power output and thrust to achieve a desired distributed propulsion matrix thrust and maintain motor temperatures of each of motors 311a-311d below a threshold temperature. Control logic 324 may be integrated in a dedicated control unit or a control unit such as a flight control computer.

With reference to liquid cooling system 220 illustrated in FIG. 2A, control logic 324 with thermal management is connected to regulators 224 and temperature sensors 326. In response to a high motor temperature, one or more of regulators 224 can be manipulated to increase the cooling capacity circulated through the one or more high temperature motors.

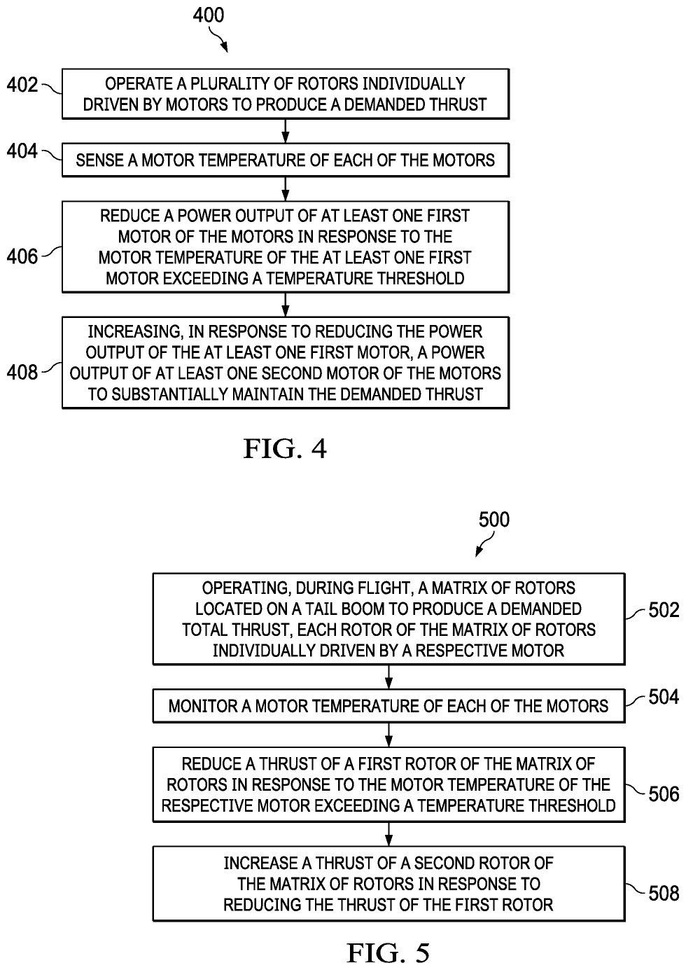

FIG. 4 is illustrates an exemplary method 400 of operating a distributed propulsion system. A block 402 a plurality of rotors 312a-312d individually driven by motors 311a-311d are operated to produce a pilot demanded thrust. Rotors 312a-312d may be fixed or variable pitch rotors and motors 311a-311d may be fixed or variable speed motors. At block 404 the temperature of motors 311a-311d are individually monitored by sensors 326. At block 406, the thrust of one or more rotors is reduced in response to the temperature of the respective one or more motors exceeding a high temperature threshold. Reducing the thrust of a rotor reduces the power output or consumption of the associated motor. For example, in an exemplary electric distributed propulsion system the motor speed of a variable speed motor driving a fixed-pitch rotor is reduced in response to the temperature of the variable speed motor exceeding a high temperature threshold. At block 408, in response to reducing power output of one or more motors and thus reducing thrust of the associated rotors, the output power of one or more of the other motors may be increased for example to maintain the demanded thrust. In an embodiment, the pitch angle of a rotor is increased and the power output of the associated motor is increased to maintain the pilot demanded net thrust. An operator, e.g., a human, may be allowed to override reducing the motor output of the high temperature motor for example to maintain a net thrust. With regard to an aircraft, the operator may be a pilot and or flight control computer of a manned or unmanned aircraft.

FIG. 5 illustrates an exemplary method 500 of operating an aircraft 100. At block 502, operating, during flight, a matrix 310 of rotors 312a-312d individually driven by motors 311a-311d to produce a pilot demanded thrust 214. At block 504, motor temperature of each of the motors is monitored. At block 506, the thrust of at least one of the rotors is reduced in response to the associated motor reaching a motor temperature threshold. At block 508, the thrust of one or more second rotors of the matrix of rotors is increased to maintain the demanded thrust.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A distributed propulsion system with thermal management, the system comprising:
two or more rotors individually controlled by associated motors; and
an input control connected to the associated motors to demand the associated motors produce a demanded thrust, wherein a motor power output of each motor of the associated motors is independently controlled to produce the demanded thrust and to control a motor temperature of one or more of the associated motors.

2. The system of claim 1, wherein the motor temperature of each of the associated motors is sensed.

3. The system of claim 1, wherein the two or more rotors are included in an aircraft.

4. The system of claim 1, wherein the two or more rotors are in an anti-torque matrix.

5. The system of claim 1, wherein the motor power output comprises motor speed or motor torque.

6. A method of operating a distributed propulsion system with thermal management, the method comprising:
operating a plurality of rotors individually driven by motors to produce a demanded thrust;
sensing a motor temperature of each of the motors;
reducing a power output of at least one first motor of the motors in response to the motor temperature of the at least one first motor exceeding a temperature threshold; and
increasing, in response to reducing the power output of the at least one first motor, a power output of at least one second motor of the motors to substantially maintain the demanded thrust.

7. The method of claim 6, further comprising allowing an operator to override reducing the power output of the at least one first motor.

8. The method of claim 6, wherein the plurality of rotors are fixed pitch rotors and the motors are variable speed motors;
the reducing the power output of the at least one first motor comprises reducing motor speed; and
the increasing the power output of the at least one second motor comprises increasing motor speed.

9. The method of claim 8, further comprising allowing an operator to override reducing the power output of the at least one first motor.

10. The method of claim 6, wherein the plurality of rotors are variable pitch rotors; and
the reducing the power output of the at least one first motor comprises at least one of reducing motor speed and changing rotor pitch; and
the increasing the power output of the at least one second motor comprises at least one of increasing motor speed and changing rotor pitch.

11. The method of claim 10, further comprising allowing an operator to override reducing the power output of the at least one first motor.

12. The method of claim 6, wherein the motors are hydraulic motors.

13. A method of operating a helicopter, the method comprising:
operating, during flight, a matrix of rotors located on a tail boom to produce a demanded total thrust, each rotor of the matrix of rotors individually driven by a respective motor;
monitoring a motor temperature of each of the motors;
reducing a thrust of a first rotor of the matrix of rotors in response to the motor temperature of the respective motor exceeding a temperature threshold; and
increasing a thrust of a second rotor of the matrix of rotors in response to reducing the thrust of the first rotor.

14. The method of claim 13, further comprising allowing an operator to override reducing the thrust of the first rotor to maintain the demanded total thrust.

15. The method of claim 13, comprising increasing, in response to reducing the thrust of the first rotor, the thrust of at least two second rotors of the matrix of rotors and substantially maintaining the demanded total thrust.

16. The method of claim 13, comprising reducing the thrust of at least two first rotors of the matrix of rotors in response to the motor temperature of the at least two respective motors exceeding a temperature threshold.

17. The method of claim 16, further comprising allowing an operator to override reducing the thrust of one or more of the at least two first rotors to maintain the demanded total thrust.

18. The method of claim 16, comprising increasing, in response to reducing the thrust of the at least two first rotors, the thrust of at least two second rotors of the matrix of rotors and substantially maintaining the demanded total thrust.

19. The method of claim 18, further comprising operating the thrust of the at least two second rotors at different thrusts.

20. The method of claim 18, further comprising allowing an operator to override reducing the thrust of one or more of the at least two first rotors to maintain the demanded total thrust.
